(19) United States
(12) Patent Application Publication
(10) Pub. No.: US 2024/0202078 A1
(43) Pub. Date: Jun. 20, 2024

(54) INTELLIGENT BACKUP SCHEDULING AND SIZING

(71) Applicant: ServiceNow, Inc., Santa Clara, CA (US)

(72) Inventors: MD Fasahath Ur Rahman, Hyderabad (IN); Apoorva Ventrapragada, Hyderabad (IN); Prabodh Saha, Hyderabad (IN); Madhav Manthri, Hyderabad (IN); Abhishek Ganguly, Hyderabad (IN)

(21) Appl. No.: 18/083,046

(22) Filed: Dec. 16, 2022

(51) Int. Cl. G06F 11/14; G06N 20/00

(52) U.S. Cl. CPC G06F 11/1461; G06N 20/00; G06F 2201/84

(57) ABSTRACT

Future computer resource utilizations are predicted using at least one machine learning model among a group of one or more trained machine learning models. Based on the predicted future computer resource utilizations, a backup time is determined. An amount of storage to reserve for a backup is estimated using at least one machine learning model among the group of one or more trained machine learning models. At the backup time, the backup is initiated to a portion of the storage reserved based on the estimated amount.

### BACKGROUND OF THE INVENTION

Cloud-based solutions allow businesses to rapidly build and deploy application services via a cloud-hosted service platform. Unlike self-hosting, cloud-hosted software and hardware can be quickly scaled up and down to provide customers with increased flexibility and control. Moreover, customers can also easily add new business application services including the ability to automate and extend new business workflows. Among the many advantages of cloud-hosted services are improved reliability and simplified IT management. This includes utilizing the cloud-hosted service to perform management responsibilities related to performing backups, migration, and restoration.

### BRIEF DESCRIPTION OF THE DRAWINGS

Various embodiments of the invention are disclosed in the following detailed description and the accompanying drawings.

FIG. 1 is a block diagram illustrating an embodiment of an intelligent backup scheduling and sizing system.

FIG. 2 is a flow chart illustrating an embodiment of a process for performing an intelligent backup.

FIG. 3 is a flow chart illustrating an embodiment of a process for scheduling an intelligent backup.

FIG. 4 is a flow chart illustrating an embodiment of a process for predicting future resource utilization used for scheduling an intelligent backup.

FIG. 5 is a flow chart illustrating an embodiment of a process for reserving storage requirements for an intelligent backup.

FIG. 6 is a flow chart illustrating an embodiment of a process for predicting storage requirements used for performing an intelligent backup.

FIG. 7 is a functional diagram illustrating a programmed computer system for an intelligent backup scheduling and sizing system in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Intelligent backup scheduling and sizing is disclosed. Using one or more trained machine learning models, the future utilization of a service and the required size of its backup are predicted and used to optimize the backup of the service. For example, utilization predictions are made over the intended backup periods and are used to identify optimal times for performing backups of the relevant service nodes. By scheduling the backup during a period with reduced resource utilization, the backup process is performed during an optimal window. In various embodiments, intelligent scheduling allows a backup to be performed with fewer resources and with significantly improved performance. As part of the backup process, the amount of storage reserved for the backup is estimated using one or more trained machine learning models. The predicted backup storage amount is used to reserve the appropriate needed storage allocation. By predicting an accurate storage allocation, failures resulting from under-reservation and resources wasted due to over-reservation are avoided. The intelligent sizing of backup storage allows for not only improved backup performance but also overall improved performance for other entities that utilize and compete for the same storage resources.

In some embodiments, a determination to perform a backup is made. For example, a backup of a service is scheduled to be performed. The backup can be one of a variety of backup types or levels, such as daily or weekly backups as well as incremental or full backups. The service being backed up can be implemented across one or more nodes, such as one or more service nodes. In some embodiments, the service nodes are application and/or database nodes. In some embodiments, future computer resource utilizations are predicted using at least one machine learning model among a group of one or more trained machine learning models. For example, resource utilization using metrics such as transaction load is used to predict future utilizations. In some embodiments, at least one machine learning model is trained with a time-series of historical resource utilization metrics to predict future levels of computer resource utilizations. A backup time is determined based on the predicted future computer resource utilizations. For example, the predicted future computer resource utilizations are analyzed to identify a backup time or backup time window that is optimal for performing a backup.

In some embodiments, an amount of storage to reserve for a backup is estimated using at least one machine learning model among the group of one or more trained machine learning models. For example, features of a service are used to predict the storage requirements of a backup. Example features can include properties related to data size, attachment size, log size, encryption formats, compression formats, instance purpose, delta transactions, and/or backup level, among others. In some embodiments, the backup is initiated, at the backup time, to a portion of the storage reserved based on the estimated amount. For example, using the determined backup time, the backup is initiated to a reserved storage. In various embodiments, the backup is performed by first reserving the predicted storage estimated and backing up to the reserved storage location. By scheduling the backup using the predicted future computer resource utilizations and to the storage reserved based on the estimated amount, the backup process is optimized to reduce resource requirements as well as to minimize over-reservation and under-reservation for storage.

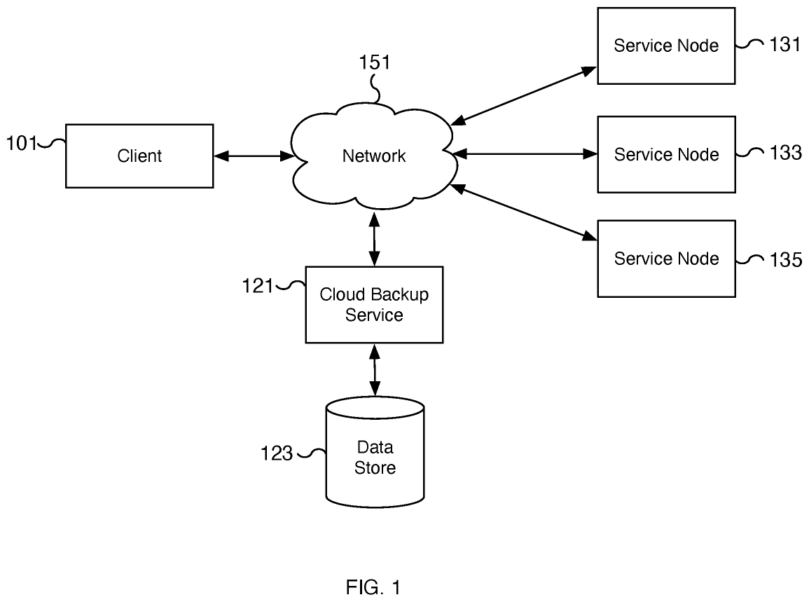

FIG. 1 is a block diagram illustrating an embodiment of an intelligent backup scheduling and sizing system. In the example shown, client 101 accesses one or more services hosted by service nodes 131, 133, and/or 135 via network 151. Service nodes 131, 133, and/or 135 are backed up via cloud backup service 121 via network 151 to data store 123. In some embodiments, client 101 is an administrative client used to manage and request backups such as daily and/or weekly backups. Network 151 can be a public or private network. In some embodiments, network 151 is a public network such as the Internet. The services hosted by service nodes 131, 133, and/or 135 can be a variety of cloud-based services including services for managing digital workflows for enterprise operations. In various embodiments, service nodes 131, 133, and/or 135 are stateless and/or stateful and are implemented as application nodes, database nodes, and/or other appropriate service nodes. In the example shown, the hosted services can be distributed across different nodes such as service nodes 131, 133, and/or 135.

In some embodiments, client 101 is a network client for accessing services of service nodes 131, 133, and/or 135 and/or managing and/or administrating backups of service nodes 131, 133, and/or 135. For example, using a web browser client, client 101 can access web services hosted by service nodes 131, 133, and/or 135. In some embodiments, client 101 is a desktop computer, a laptop, a mobile device, a tablet, a kiosk, a voice assistant, a wearable device, or another network computing device. In various embodiments, client 101 can also be used to request the scheduling of intelligent backups of service nodes 131, 133, and/or 135 and/or services associated with service nodes 131, 133, and/or 135. For example, client 101 can be used to request incremental daily backups and/or weekly full backups of service nodes 131, 133, and/or 135 that are performed by cloud backup service 121 at optimal time windows based on predicted resource utilizations using one or more trained machine learning models.

In some embodiments, cloud backup service 121 offers cloud-based intelligent backups based on predicted resource utilizations of the resources to be backed up. For example, using one or more trained machine learning models, cloud backup service 121 predicts the optimal window for performing a backup. In advance of performing the backup, cloud backup service 121 further estimates the storage requirements for the backup and reserves the appropriate estimated storage. For example, using one or more trained machine learning models, cloud backup service 121 predicts the appropriate storage required to reserve from data store 123 for a backup. By accurately predicting the storage requirements of a backup, cloud backup service 121 can prevent under-reservation and over-reservation of the limited storage resource of data store 123. In various embodiments, cloud backup service 121 includes one or more machine learning training servers used to train one or more machine learning models for predicting backup scheduling windows and/or backup storage requirements. Similarly, in various embodiments, cloud backup service 121 includes one or more inference servers for performing the associated predictions.

In some embodiments, data store 123 is utilized by cloud backup service 121 for storing and/or retrieving backup data. For example, backups of service nodes 131, 133, and 135 are stored at and restored from data store 123. In advance of storing a backup, cloud backup service 121 can reserve a storage amount from data store 123 to ensure that the backup completes successfully without running out of storage. Similarly, cloud backup service 121 can reserve an accurate storage amount to ensure that only the appropriate amount of storage is reserved. This helps to prevent over-reservation, which can result in preventing other entities from accessing unused and shared storage resources of data store 123 when more storage is reserved than needed by the backup. In some embodiments, data store 123 is implemented using one or more data stores such as one or more distributed data storage servers. For example, although shown as a single entity in FIG. 1, data store 123 can be implemented as one or more distributed data store components connected via network 151 to cloud backup service 121 and services nodes 131, 133, and 135.

In some embodiments, service nodes 131, 133, and 135 are service nodes such as application nodes, database nodes, or other appropriate nodes for implementing cloud-based services. The nodes can be stateless and/or stateful and can require routine backup such as daily incremental backups and/or weekly full backups. In some embodiments, the services can be distributed across the different nodes and each node can host one or more different customers. In some embodiments, different customers are assigned to different service nodes. In various embodiments, backups of service nodes 131, 133, and 135 are scheduled and performed by cloud backup service 121 using an intelligent backup scheduling and sizing process. In some embodiments, the backups are scheduled based on customer, service, and/or nodes utilized.

Although single instances of some components have been shown to simplify the diagram of FIG. 1, additional instances of any of the components shown in FIG. 1 may exist. For example, cloud backup service 121, data store 123, and/or service nodes 131, 133, and 135 may include one or more servers and/or may share servers. Furthermore, client 101 is just one example of a potential client to cloud backup service 121 and/or service nodes 131, 133, and 135. Similarly, data store 123 may include one or more data store servers. In some embodiments, data store 123 may not be directly connected to cloud backup service 121. For example, data store 123 and its components may be replicated and/or distributed across multiple servers and/or components. In some embodiments, components not shown in FIG. 1 may also exist.

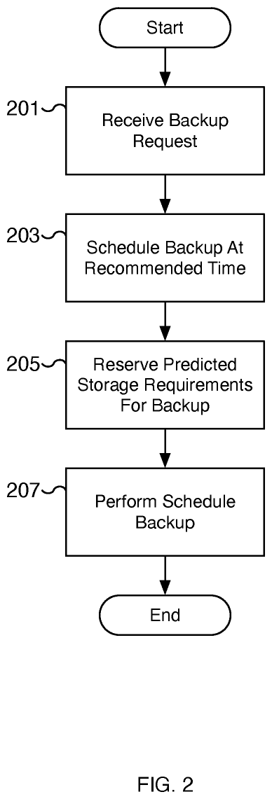

FIG. 2 is a flow chart illustrating an embodiment of a process for performing an intelligent backup. In various embodiments, a backup request is received by a cloud backup service. In response to the backup request, the cloud backup service determines an optimal time for performing a backup based at least on predicting the computer resource utilizations associated with the service. Further, ahead of performing the backup, the cloud backup service determines and reserves the appropriate storage allocation required by the backup. In various embodiments, the predicted resource utilizations and estimated storage requirement are both predicted using one or more machine learning models. In some embodiments, the request to perform the backup is initiated via a client such as client 101 of FIG. 1. In some embodiments, the process of FIG. 2 is performed by a cloud backup service such as cloud backup service 121 of FIG. 1 and the backup is stored at a data store such as data store 123 of FIG. 1. In some embodiments, the service backed up is associated with service nodes 131, 133, and/or 135 of FIG. 1.

At 201, a backup request is received. For example, a cloud backup service receives an administrative and/or management request to schedule a backup for a service. The backup can specify a frequency for the backup to occur, such as daily, weekly, bi-weekly, monthly, or another frequency. The backup can also specify the type of backup to perform, such as an incremental backup or a full backup. In various embodiments, the backup request specifies the customer, service, and/or nodes for which the backup will be performed.

At 203, a backup is scheduled at a recommended time. For example, future resource utilizations are predicted using one or more trained machine learning models. Based on the predicted utilizations, an optimal time window for performing the backup is determined and the backup is scheduled for the determined window. In some embodiments, the predicted utilizations include predicted transactions such as database transactions and/or file system transactions. In some embodiments, the transactions are atomic transactions and are used at least in part for maintaining a consistent state for the service. In various embodiments, the machine learning models are trained using past resource utilizations and/or the length of the backup is determined based on the length of previous backups.

At 205, the predicted storage requirements for the backup are reserved. For example, one or more backup storage requirements are estimated and reserved ahead of performing the backup. In various embodiments, the reserved storage amount is predicted using one or more machine learning models. For example, one or more models are trained using features of the service such as properties related to data size, attachment size, log size, encryption formats, compression formats, instance purpose, delta transactions, and/or backup level, among others.

At 207, the scheduled backup is performed. For example, the cloud backup service performs the requested backup at the scheduled time to the reserved storage resource. In various embodiments, the backup takes place at the scheduled time window where resource utilizations are reduced and where storage reservation requirements are optimal. The backup performed utilizes the recommended time scheduled at 203 and the storage requirements reserved at 205. In some embodiments, the results of the backup performed are used for further training of the machine learning models to ensure accurate predictions for future backups. For example, the storage requirements of the backup performed at 207 can be used to update the relevant storage prediction models.

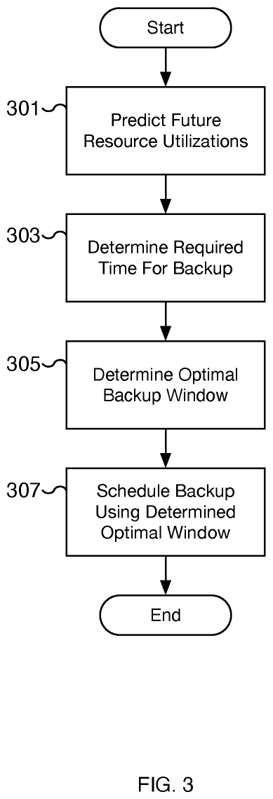

FIG. 3 is a flow chart illustrating an embodiment of a process for scheduling an intelligent backup. For example, by using one or more trained machine learning models to predict resource utilizations, a recommended backup time or time window can be determined. The determined backup time is used for scheduling an intelligent backup that minimizes overlap of the backup processing with resource utilizations. In some embodiments, the backup is scheduled for a requested window, such as a window within a specific day for a daily backup or a window within a specific week for a weekly backup. In some embodiments, the process of FIG. 3 is performed at 203 of FIG. 2 by a cloud backup service such as cloud backup service 121 of FIG. 1.

At 301, future resource utilizations are predicted. For example, using one or more trained machine learning models, future resource utilizations are predicted based on the requested backup period. For a daily backup, the future resource utilizations for a day are predicted. Similarly, for a weekly backup, the future resource utilizations for an entire week are predicted. The predicted utilizations correspond to the resource utilizations for a time period from which a time slice will be utilized to perform a requested backup. In some embodiments, the predicted resource utilizations are computer resource utilizations and can include transactions such as delta transactions and/or database transactions.

At 303, the time required for the backup is determined. For example, based on the type of backup requested, the amount of time required to perform the backup is determined. In some embodiments, the determined time length is an estimated and/or approximated length of time. The determined time required can be based on analyzing similar backups performed in the past (i.e., using historical data) and can be weighted more heavily to more recent and/or more similar backups. For example, previous daily incremental backups are used to determine the time required for a requested daily incremental backup. In some embodiments, the time required is predicted using one or more trained machine learning models.

At 305, an optimal backup window is determined. Based on the utilizations predicted at 301 and the time required determined at 303, an optimal backup window for performing backup is determined. In some embodiments, the time determined is a window of time that spans the required time determined at 303. In some embodiments, the time determined is a start time for starting the backup. In some embodiments, the time determined includes an end time for when the backup must be completed. In some embodiments, the backup time is a time window that includes a start time and an approximate and/or estimated end time.

At 307, the backup is scheduled using the determined optimal window. For example, a backup is scheduled using the optimal backup window determined at 305. In various embodiments, once the backup is scheduled, additional backup operations are later performed such as reserving the required storage needed to complete the backup.

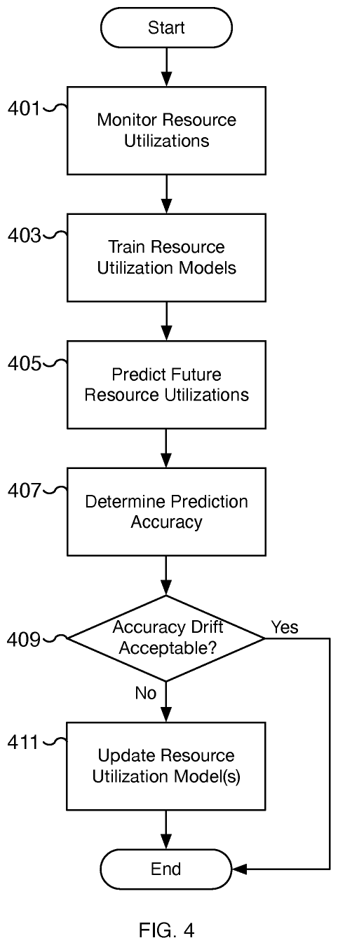

FIG. 4 is a flow chart illustrating an embodiment of a process for predicting future resource utilization used for scheduling an intelligent backup. For example, one or more machine learning models are trained to predict resource utilizations for a service using data such as past operating performance. In some embodiments, the training data includes operating characteristics of the service such as properties of delta transactions, properties of database transactions, CPU utilizations, memory utilizations, disk and/or storage access, etc. Once trained, the machine learning models are continuously evaluated and updated to ensure the accuracy of future predictions. In some embodiments, the process of FIG. 4 is performed at 203 of FIG. 2 and/or at 301 of FIG. 3 by a cloud backup service such as cloud backup service 121 of FIG. 1. In some embodiments, the cloud backup service includes one or more machine learning training servers for training the machine learning models and one or more machine learning inference servers for prediction resource utilization results.

At 401, resource utilizations are monitored. For example, the service to be backed up is monitored and data of resource utilizations is gathered. Example resource utilization characteristics include the number and properties of transactions including database and delta transactions. Additional utilization characteristics include CPU utilization, memory utilization, disk and/or storage access, etc. In various embodiments, the data can be gathered using agents and/or monitoring probes associated with the appropriate service nodes.

At 403, one or more resource utilization models are trained. Using the resource utilizations data gathered at 401, one or more resource utilization models are trained. In some embodiments, the data gathered at 401 is first preprocessed and then used to train one or more machine learning models used for resource utilization prediction. In various embodiments, the training data includes historical operating data for the relevant services that require backing up. In some embodiments, the training data includes time series information used to date the different data.

At 405, future resource utilizations are predicted. For example, future resource utilizations are predicted using the models trained at 403 for the requested period associated with a backup. For example, for a daily backup, the future resource utilizations for a day are predicted and for a weekly backup, the future resource utilizations for an entire week are predicted. The predicted utilizations correspond to the resource utilizations for a time period from which a time slice will be utilized to perform a requested backup. In various embodiments, the predicted future resource utilizations are utilization metrics such as CPU utilizations, storage utilizations, memory utilizations, and/or delta transactions metrics, among other metrics. For example, in some embodiments, the predicted future resource utilizations are the expected amounts of delta transactions.

At 407, the prediction accuracy is determined. For example, the actual resource utilizations of the service are monitored and used to determine the accuracy of the resource utilizations predicted at 405. By evaluating the difference between actual results and predicted results, an accuracy drift associated with the prediction results can be determined. In many scenarios, the prediction accuracy will worsen over time as the trained model becomes less accurate and more dated. By determining the prediction accuracy at 407, the accuracies of the current models are evaluated and used to determine when they may require updates.

At 409, a determination is made whether the drift in accuracy is acceptable. In the event the drift in accuracy is acceptable, the resource utilization models are not updated and processing for FIG. 4 completes. In the event the drift in accuracy is not acceptable, processing proceeds to 411 where the appropriate resource utilization models are updated. For example, in some scenarios, in the event the actual and predicted results are off by more than a threshold amount more than a threshold number of times (i.e., by more than 20% more than three times), the drift in accuracy can be considered not acceptable.

At 411, one or more resource utilization models are updated. For example, using the more recent data gathered from monitoring the relevant services, the trained machine learning models for resource utilization prediction are updated. In some embodiments, the more recent data is more heavily weighted in order to more accurately predict resource utilizations. Similarly, dated or stale data can be removed from the training data. In some embodiments, the models are updated using a training method similar to the techniques described with respect to steps 401 and 403.

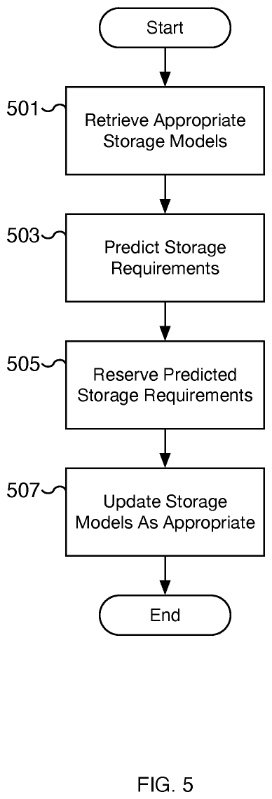

FIG. 5 is a flow chart illustrating an embodiment of a process for reserving storage requirements for an intelligent backup. For example, by using one or more trained machine learning models to predict backup storage requirements, storage requirements can be reserved ahead of performing the backup. By reserving at least the storage needed for the backup, the backup process will not fail due to a lack of available storage. Further, by not over reserving the amount of storage needed for the backup, the backup process will not tie up storage resources that other entities can utilize. In various embodiments, the machine learning models are trained and updated as needed to ensure that the predicted resource requirements are accurate. In some embodiments, the process of FIG. 5 is performed at 205 of FIG. 2 by a cloud backup service such as cloud backup service 121 of FIG. 1 and the storage reserved is from a data store such as data store 123 of FIG. 2.

At 501, the appropriate storage models are retrieved. For example, the models associated with a requested backup, such as one or more specific models trained for the customer requesting the backup for the customer's services and/or nodes, are retrieved. In various embodiments, different models are trained for each customer, service, and/or nodes and different models can be used to predict different storage requirements.

At 503, storage requirements are predicted. For example, the storage requirements associated with a backup are predicted. In some embodiments, the predicted storage requirements include the amount of storage needed to perform the backup. In various embodiments, the requirements may include different storage requirements depending on the type of backup. For example, some backups may require storing to different storage locations, including different types of storage, and each location may require a different estimated storage amount. In various embodiments, the predicted storage amounts will not underestimate the required storage and may allow for a configured and/or allowable buffer that exceeds the required storage to prevent an estimate that under-estimates the required amount.

At 505, the predicted storage requirements are reserved. For example, using the storage requirements predicted at 503, the required storage amounts are reserved from the appropriate storage locations. In some embodiments, each reserved storage is reserved from a data store and a reservation prevents other entities from accessing the reserved storage.

At 507, the storage models are updated as appropriate. For example, the storage models used to predict storage requirements are updated when they are no longer up to date and capable of accurately predicting storage requirements. In some embodiments, the accuracy of the models is determined by evaluating the predicted requirements from the actual backup requirements. In some embodiments, a penalty factor is used to prevent the accuracy of the storage models from deviating too much. For example, when the penalty is no longer within the allowance, the models are updated to maintain the accuracy of the predictions for storage requirements.

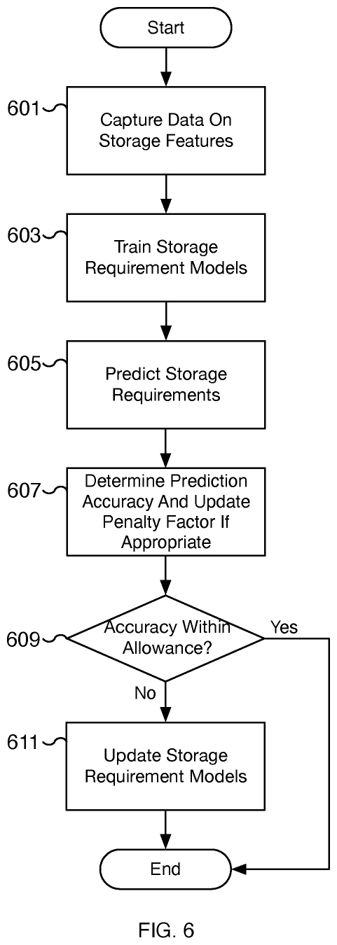

FIG. 6 is a flow chart illustrating an embodiment of a process for predicting storage requirements used for performing an intelligent backup. For example, one or more machine learning models are trained to predict storage requirements, such as the amount of storage needed, for performing a backup. In some embodiments, the training data includes backup properties related to data size, attachment size, log size, encryption formats, compression formats, instance purpose, delta transactions, and/or backup level, among others. Once trained, the machine learning models are continuously evaluated and updated to ensure the accuracy of future predictions. In some embodiments, the process of FIG. 6 is performed at 205 of FIG. 2 and/or at 503 of FIG. 5 by a cloud backup service such as cloud backup service 121 of FIG. 1. In some embodiments, the required storage requirements relate to storage amounts reserved on a data store such as data store 123 of FIG. 1. In some embodiments, the cloud backup service includes one or more machine learning training servers for training the machine learning models and one or more machine learning inference servers for prediction resource utilization results.

At 601, data on storage features is captured. For example, data on features used for training the machine learning models is captured. The data for features can include storage properties of the service and/or nodes being backed up such as properties related to data size, attachment size, log size, encryption format, compression format, instance purpose, delta transactions, and/or backup level, among others. In various embodiments, these captured data for features impact the backup storage requirements. For example, whether an encryption and/or compression format is used and the associated properties of a used encryption and/or compression format will impact the amount of storage required for a backup. In some embodiments, the instance purpose describes the use case for a service such as a production deployment, a development deployment, or failover deployment, or another use case. In various embodiments, a backup level describes the type of backup such as an incremental backup or a full backup.

At 603, one or more storage requirement models are trained. For example, using the storage features captured at 601, one or more storage requirement models are trained for each customer, service, and/or node. In some embodiments, the data gathered at 601 is first preprocessed and then used to train one or more machine learning models used for the prediction of storage requirements. In various embodiments, the training data includes historical data for the relevant services that require backing up. In some embodiments, the training data includes time series information used to date the different data.

At 605, storage requirements are predicted. For example, storage resource requirements including the amount of storage required for a backup are predicted. In various embodiments, the predicted requirements are based on a scheduled backup and can take into account the time of the backup. For example, depending on the backup window during which a backup is performed, a backup can require different storage amounts due to factors such as changes in delta transactions. In various embodiments, the predicted resource requirements correspond to, at a minimum, the necessary storage required to perform a backup without running out of storage. In some embodiments, the predicted storage requirements are estimates of the storage needs for the backup and the estimated amounts are used to reserve the storage resources required for performing the corresponding backup.

At 607, the prediction accuracy is determined and a penalty factor is updated if appropriate. For example, the actual storage resources used when performing the backup are monitored and compared to the accuracy of the predictions made at 605. By evaluating the difference between actual results and predicted results, a prediction accuracy can be determined. In some embodiments, a penalty is determined to evaluate whether the accuracy of the models is no longer sufficient. In many scenarios, the prediction accuracy can worsen over time as the trained model becomes less accurate and more dated. For example, data growth, attachment size growth, and/or log file size growth may deviate from predictions. By determining the prediction accuracy at 607 and updating a penalty value, the accuracies of the current models are evaluated to determine when they need updating.

In some embodiments, the intelligent backup system requires that storage predictions are never underestimated such that the amount of storage predicted is never lower than the actual required storage. A penalty factor to tune the models can target never underestimating the storage requirements and function as a feedback mechanism to enforce this requirement. In various embodiments, the penalty factor can increase, potentially exponentially, as the predicted values differ from the actual values, and the penalty factor can increase more significantly for underestimates than overestimates. For example, underestimates can be given a larger penalty because they can result in the backup failing whereas overestimates can be given a smaller or neutral penalty since overestimates typically allow a backup to complete successfully despite possibly failing to utilize storage resources optimally. In some embodiments, a large penalty factor (such as a value of 1×10⁵) can be applied when an underestimation is detected and a neutral (or penalty factor of 1) can be applied when overestimation is detected. When the penalty or penalty factor exceeds a configured threshold, the model is updated. In some embodiments, the penalty factor is further based on the difference between the predicted storage amount and the actual storage amount such that large underestimations are penalized more. For example, a penalty value can be based on multiplying the absolute value of the difference between the predicted storage amount and the actual storage amount by the penalty factor.

In some embodiments, a feedback value, such as a value between 0.0 and 1.0, can be determined. For example, a feedback value of 1.0 can indicate that the prediction matches the actual value and a low feedback value (closer to 0.0) can indicate that a model needs updating. Using the determined feedback value, the model can be updated when the feedback value is too low based on a configured feedback threshold. In some embodiments, a separate penalty is additionally utilized to ensure that underestimations never occur. For example, in the event a prediction is an underestimate, the model can be automatically penalized and automatically updated.

At 609, a determination is made whether the prediction accuracy is within allowance. In the event the prediction accuracy is within the allowance, no storage requirement models are updated and processing for FIG. 6 completes. In the event the prediction accuracy is not within the allowance, processing proceeds to 611 where the appropriate storage requirement models are updated. In some embodiments, the determination of whether the prediction accuracy is within allowance is based on a penalty or penalty value and/or based on a feedback value.

At 611, one or more storage requirement models are updated. For example, using the penalty and/or feedback values and more recent data captured on storage features, the trained applicable machine learning models for storage requirement prediction are updated. In some embodiments, the more recent data is more heavily weighted in order to more accurately predict storage requirements. Similarly, dated or stale data can be removed from the training data. In some embodiments, the models are updated using a training method similar to the techniques described with respect to steps 601 and 603.

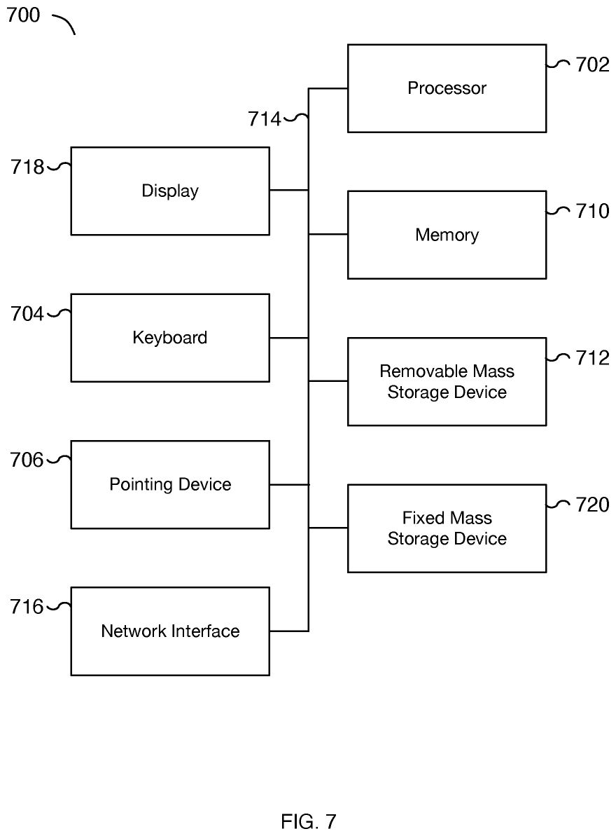

FIG. 7 is a functional diagram illustrating a programmed computer system for an intelligent backup scheduling and sizing system in accordance with some embodiments. As will be apparent, other computer system architectures and configurations can be utilized for order-preserving obfuscation of a protected dataset and/or performing comparison queries on the obfuscated data. Examples of computer system 700 include client 101 of FIG. 1, one or more computers of cloud backup service 121 of FIG. 1, one or more computers of data store 123 of FIG. 1, and/or one or more computers of service nodes 131, 133, and/or 135 of FIG. 1. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718). In various embodiments, one or more instances of computer system 700 can be used to implement at least portions of the processes of FIGS. 2-6.

Processor 702 is coupled bi-directionally with memory 710, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data and objects used by the processor 702 to perform its functions (e.g., programmed instructions). For example, memory 710 can include any suitable computer-readable storage media, described below, depending on whether, for example, data access needs to be bi-directional or unidirectional. For example, processor 702 can also directly and very rapidly retrieve and store frequently needed data in a cache memory (not shown).

A removable mass storage device 712 provides additional data storage capacity for the computer system 700, and is coupled either bi-directionally (read/write) or unidirectionally (read only) to processor 702. For example, storage 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of mass storage 720 is a hard disk drive. Mass storages 712, 720 generally store additional programming instructions, data, and the like that typically are not in active use by the processor 702. It will be appreciated that the information retained within mass storages 712 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
predicting future computer resource utilizations using at least one machine learning model among a group of one or more trained machine learning models;
determining a backup time based on the predicted future computer resource utilizations;
estimating an amount of storage to reserve for a backup using at least one machine learning model among the group of one or more trained machine learning models; and
initiating, at the backup time, the backup to a portion of the storage reserved based on the estimated amount.

2. The method of claim 1, wherein the future computer resource utilizations are predicted based on one or more of the following: delta transactions, database transactions, processor utilizations, memory utilizations, or computer storage access.

3. The method of claim 1, wherein estimating the amount of storage to reserve for the backup is based on one or more of the following: data size, attachment size, log size, encryption format, compression format, instance purpose, delta transactions, or backup level.

4. The method of claim 1, further comprising receiving a request to perform the backup, wherein the request specifies a frequency of the backup.

5. The method of claim 4, wherein the frequency of the backup is a daily frequency or a weekly frequency.

6. The method of claim 1, further comprising determining an estimated amount of time required for performing the backup.

7. The method of claim 6, wherein the determined estimated amount of time required is based on analyzing one or more previous backups.

8. The method of claim 1, wherein the backup time determined is a time window.

9. The method of claim 1, further comprising evaluating a prediction accuracy of at least one machine learning model among the group of one or more trained machine learning models.

10. The method of claim 9, further comprising, based on the evaluated prediction accuracy, determining to update at least one machine learning model among the group of one or more trained machine learning models.

11. A system comprising:
one or more processors; and
a memory coupled to the one or more processors, wherein the memory is configured to provide the one or more processors with instructions which when executed cause the one or more processors to:
predict future computer resource utilizations using at least one machine learning model among a group of one or more trained machine learning models;
determine a backup time based on the predicted future computer resource utilizations;
estimate an amount of storage to reserve for a backup using at least one machine learning model among the group of one or more trained machine learning models; and
initiate, at the backup time, the backup to a portion of the storage reserved based on the estimated amount.

12. The system of claim 11, wherein the future computer resource utilizations are predicted based on one or more of the following: delta transactions, database transactions, processor utilizations, memory utilizations, or computer storage access.

13. The system of claim 11, wherein estimating the amount of storage to reserve for the backup is based on one or more of the following: data size, attachment size, log size, encryption format, compression format, instance purpose, delta transactions, or backup level.

14. The system of claim 11, wherein the memory is further configured to provide the one or more processors with instructions which when executed cause the one or more processors to receive a request to perform the backup, wherein the request specifies a frequency of the backup.

15. The system of claim 14, wherein the frequency of the backup is a daily frequency or a weekly frequency.

16. The system of claim 11, wherein the memory is further configured to provide the one or more processors with instructions which when executed cause the one or more processors to determine an estimated amount of time required for performing the backup.

17. The system of claim 16, wherein the determined estimated amount of time required is based on analyzing one or more previous backups.

18. The system of claim 11, wherein the memory is further configured to provide the one or more processors with instructions which when executed cause the one or more processors to evaluate a prediction accuracy of at least one machine learning model among the group of one or more trained machine learning models.

19. The system of claim 18, wherein the memory is further configured to provide the one or more processors with instructions which when executed cause the one or more processors to, based on the evaluated prediction accuracy, determine to update at least one machine learning model among the group of one or more trained machine learning models.

20. A computer program product, the computer program product being embodied in a non-transitory computer readable storage medium and comprising computer instructions for:
predicting future computer resource utilizations using at least one machine learning model among a group of one or more trained machine learning models;
determining a backup time based on the predicted future computer resource utilizations;
estimating an amount of storage to reserve for a backup using at least one machine learning model among the group of one or more trained machine learning models; and
initiating, at the backup time, the backup to a portion of the storage reserved based on the estimated amount.
